(19) United States
(12) Patent Application Publication
(10) Pub. No.: US 2009/0024362 A1
(43) Pub. Date: Jan. 22, 2009

(54) VIRTUAL BACKLIGHT FRAMEWORK

(75) Inventor: Brian L. Linzie, River Falls, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/133,886

(22) Filed: Jun. 5, 2008

Related U.S. Application Data
(60) Provisional application No. 60/951,025, filed on Jul. 20, 2007.

(51) Int. Cl. G06F 17/50

(52) U.S. Cl. 703/1

(57) ABSTRACT

A software interface for designing backlights is disclosed. The software has three particular aspects, summarized briefly here. In one embodiment, a first aspect is “sharing” or “collaborating”, in which any users in a group can read and write annotated components, annotated designs and annotated results. In another embodiment, a second aspect is “metadata”, in which the software automatically analyzes the components, the design, and/or the results. In another embodiment, a third aspect is “workflow driven”, in which the software first provides a graphical user interface for selecting options, then the user selects one or more options, then the software provides a further graphical user interface for providing detail information, then the user provides detail information for a cavity and/or one or more backlight components.

### CROSS REFERENCE TO RELATED APPLICATION

This application claims the benefit of U.S. Provisional Patent Application No. 60/951,025, filed Jul. 20, 2007, the disclosure of which is incorporated by reference herein in its entirety.

### FIELD OF THE INVENTION

The present invention is directed to a framework for simulating and designing backlights.

### BACKGROUND

In order to produce and analyze backlight designs in a timely manner, it is necessary to perform computer simulations of the design iterations. In many cases, the software that performs the simulations may require an undesirably high level of sophistication from the user. Existing software may be difficult to use and require extensive training. As a result, it is highly desirable to reduce the complexity of the simulation software interface, so that a less experienced user may adequately perform the simulations without the need for additional training and expense. In addition, due to the iterative nature of backlight design, and due to the extensive data that are typically generated, it is desirable to have the system aid in, organize, and analyze the intermediate products and final products of backlight designs.

In addition, there may be more than one designer within a company or organization. In many cases, it is beneficial to encourage collaboration among the various designers, so that information may be shared, redundancies may be reduced, and efficiency may be increased. Accordingly, it may be advantageous for the simulation software to allow collaboration among the designers.

### BRIEF SUMMARY

An embodiment is an application server for interacting with a plurality of users through respective user computers to design a backlight, the application server being configured for: receiving design information relating to a backlight or component(s) thereof from at least one of the users; generating a backlight design as a function of the design information; simulating the backlight design to produce performance results; receiving from at least one of the users annotation data relating to at least one of: (a) the backlight or the component(s) thereof, or (b) the performance results; annotating the backlight design, the component(s) thereof, and/or the performance results with the annotation data; and providing the annotation data to the users.

A further embodiment is a computer system for interacting with at least one user to design a backlight, the computer system being configured for: receiving a plurality of design information relating to at least one backlight or component(s) thereof from at least one user; generating at least one backlight design as a function of the design information; simulating the at least one backlight design to produce performance results; analyzing automatically at least one of: (a) the plurality of design information, or (b) the at least one backlight design or the component(s) thereof, or (c) the performance results, to produce analytical information; and providing the analytical information to the at least one user.

A further embodiment is a computer system for interacting with at least one user to design a backlight, the computer system being configured to execute the steps of: (a) providing a first graphical user interface containing a plurality of selectable cavity design options; (b) receiving the selected cavity design options from the user; (c) after step (b), providing a second graphical user interface adapted to receive cavity detail information, the type of cavity detail information being a function of the cavity design options selected by the user; (d) receiving the cavity detail information from the user; (e) providing a third graphical user interface containing a plurality of selectable backlight component options; (f) receiving the selected backlight component options from the user; (g) after step (f), providing a fourth graphical user interface adapted to receive component detail information, the type of component detail information being a function of the backlight component options selected by the user; and (h) receiving the component detail information from the user.

### BRIEF DESCRIPTION OF THE DRAWINGS

FIG. 1 is a flow chart of the “sharing” or “collaborating” aspect of the backlight design software.

FIG. 2 is a flow chart of the “metadata” aspect of the backlight design software.

FIG. 3 is a flow chart of the “workflow driven” aspect of the backlight design software.

FIGS. 4A-B include a flow chart of an exemplary interface of backlight design software.

### DETAILED DESCRIPTION OF ILLUSTRATIVE EMBODIMENTS

Backlights are becoming increasingly prevalent in many devices, such as cell phones, computer displays and monitors, and televisions. In many of these devices, the backlight provides a source of light, which is attenuated on a pixel-by-pixel basis by an element placed between the backlight and the viewer. In most cases, it is highly desirable that the backlight output be essentially uniform over the full area of the display, with additional directional and spectral requirements that are particular for each application.

These backlights typically contain one or more light generators, one or more reflecting surfaces, and one or more thin films that can diffuse, reflect, polarize, and/or otherwise condition or process the light incident upon them to achieve a desired backlight output. During the design phase, it is highly desirable to perform computer simulations of proposed systems, rather than build a mechanical prototype for each iteration or potential new design. These simulations are extremely valuable to backlight designers, who are responsible for optimizing designs and meeting performance and cost requirements in a timely and cost-effective manner.

In some cases, the backlight simulations for a company's product line are performed by several designers, each of whom is responsible for one or more products and/or revisions. With some known software, the design data and/or results data involved with a particular product may be substantial, and may not be readily available to anyone other than the individual designer who worked on it. In some cases, these data may not even be properly organized, making it unavailable later to anyone other than the designer, or even confusing to the designer himself. This data may be useful for other designers who use similar components and/or layouts, meet similar design specifications, or encounter similar obstacles in the design process. Furthermore, some of this data may allow a designer to reconstruct his train of thought, or to do a better job of organizing the design iterations. Accordingly, it would be beneficial to have a way of designing backlights so that the knowledge gained from one designer's experience may be shared easily with other designers.

It is instructive to clarify several terms that are used throughout this document. A backlight “component” refers to any element that may be specified in the software and may be used in a backlight. Backlight “components” may include, but are not limited to, light guides, thin films such as prismatic thin films, polarizers, reflectors, diffusers, absorbers, extraction features, surfaces such as diffuse reflecting surfaces or specular reflecting surfaces, partially transmitting surfaces, cavities, and light sources such as compact fluorescent bulbs, light emitting diodes, or any other suitable light sources. A backlight “component” may refer to a single element, such as a light emitting diode, or several elements, such as an array of light emitting diodes. Likewise, a backlight “component” may refer to a single thin film, such as a prismatic thin film, or several thin films, such as a stack of thin films.

In one embodiment, a user selects from a list of available components, with optional parameters that can adjust various parameters of the component, such as size, shape, surface roughness, cost and so forth. The adjustable parameters may have default values that may be altered. The user may also define new components based on templates and/or more primitive parameters. The more primitive parameters may include specifications of precise geometry, surface roughness, or other suitable quantities.

A backlight “design” refers to a collection of components and their relative geometries and/or orientations. For instance, a backlight “design” may include a light source with particular emission properties and a particular source orientation, a wave guide of a particular size with a particular orientation with respect to the source, and a prismatic thin film of a particular size with a particular orientation with respect to the wave guide.

The backlight “design” may further include a cavity of a particular size and shape that houses the other components. Note that the cavity may be hollow, solid or partially solid. For the purposes of this document, the terms “cavity” and “volume” may be interchangeable, and may refer to a physical space or volume into which components will fit. The cavity or volume may be specified by a set of points, lines, planes, or any combination thereof, and/or dimensions, such as length, width and height. Note also that the cavity may also be a unit cell, which may be part of a larger design.

In one embodiment, a user selects various components and assembles them into a design. The assembly may be done by any combination of numerical and graphical specification. For instance, the components and their relative geometries may be specified by a list of coordinates, where adjustments may be made by altering the numerical coordinates. Alternatively, the components and their geometries may be specified in a pictorial manner, by moving an icon on a display.

In one embodiment, the software may guide the user in assembling the components by providing a series of logical prompts and/or default values. For instance, if the user specifies that there should be five light sources along a particular cavity wall, the software may initially position them so that they are equally spaced apart along the wall.

Returning to terminology, a backlight “simulation” refers to one or more raytraces that are performed on the backlight design. The raytrace parameters, such as ray densities, initial positions and initial orientations, are determined by the user and/or by the software itself. Once the rays are traced, their final positions and final orientations are noted by the software and are summarized as performance “results”. Typically, the performance “results” may include the apparent brightness of the backlight as a function of viewing angle and screen location, but may also include other suitable parameters and/or values. The performance “results” may be displayed in graphical form, in tabular form, as raw data, as plots, as a rendering, as a realistic three-dimensional display, and/or as animation.

The term “analyze” as used in this document may be interpreted by one or more of its dictionary definitions, such as “to examine critically, so as to bring out the essential elements or give the essence of,” “to examine carefully and in detail so as to identify causes, key factors, possible results, etc.,” or “to subject to mathematical, chemical, grammatical, etc., analysis.”

Each component, design, or set of results may be stored as a file on a storage device or server, or may be allocated in memory in a structure analogous to a file structure. Typically, these files may include information such as a title, a description, and/or specifying data, although any suitable parameters may be stored in the respective files.

The backlight components, the backlight design and the performance results may all be annotated, independently of each other. The annotations may be saved as a separate annotation file that accompanies the respective component, design and/or results file. Alternatively, the annotations may be incorporated directly into the component files, the design files, and/or the results files. As a further alternative, the annotations may be both incorporated into the files and saved as separate files. Annotations may include any or all of comments from one or more users, design criteria, iteration or version number(s), information pertaining to related files such as similar components or earlier design revisions, or any other suitable annotation. In one embodiment, these annotations may be readable and writable for several users, not just a single user, so that knowledge and information may be shared. Note that a filename may not be considered an annotation.

There are three particular aspects of backlight designing software that are addressed in greater detail in the figures and text below, but are summarized generally in the following three paragraphs. These summaries are intended to be exemplary, and should not be construed as limiting in any way.

A first aspect may be known roughly as “sharing” or “collaborating”, in which data concerning components, designs, and/or results may be shared or distributed among a group of users. For instance, a group of designers working for a particular company may use the software to flag and/or annotate particularly good designs, so that others may use them as starting points. Or, a designer may use the software to flag a particular part that is no longer available, thereby saving other designers the trouble of producing a design that uses an unavailable component. In general, the software may use any or all of network access, organized and controlled access to self and group design information, annotation and message board features, which can promote communication among individuals and groups. In other words, the software may allow the results of others to be seen easily within a shared system (a live network), or seemingly so (a local replication of the live network).

A second aspect may be known roughly as “metadata,” or information concerning other information. For instance, designers or others interested in observing and/or managing the process of designing backlights may be able to access and interact with individual and group-level data concerned with such features as design evolution, the design spaces that have been explored, figures of merit and/or user annotation. Some elements of the metadata may be generated by the user, and others may be generated by the software.

A third aspect may be known roughly as “workflow driven,” where the software may guide the user through various options for specifying the cavity and/or component(s) for the design. In one embodiment, the software may include a so-called “backlight wizard” that can guide the user through a selection of menu-driven choices and/or adjustable default values to specify the backlight design.

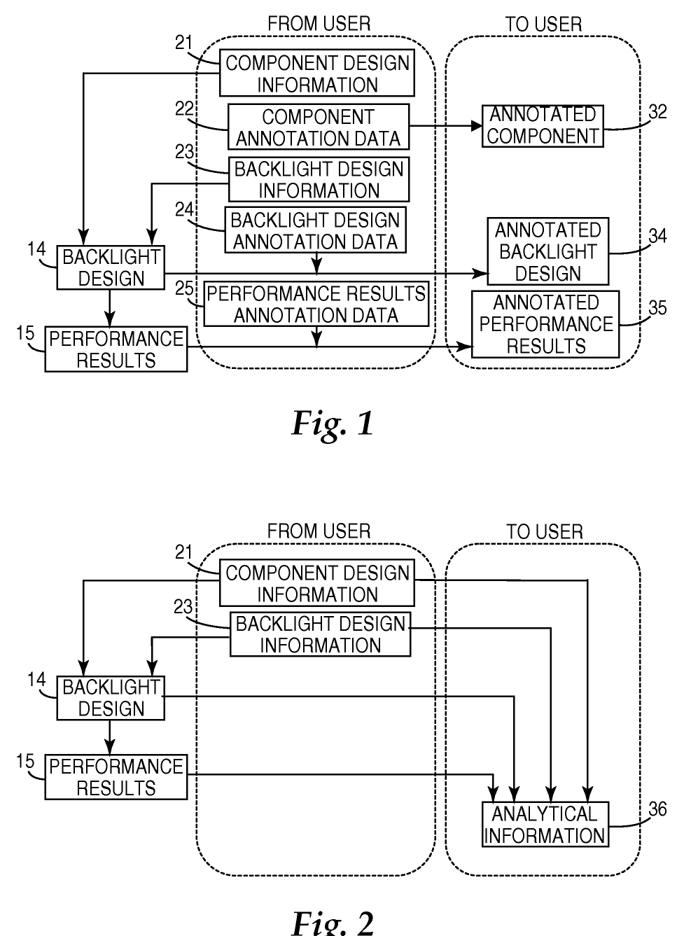

The three aspects summarized above are merely exemplary, and are not intended to be limiting in any way. These three aspects are shown schematically in FIGS. 1 through 3, respectively, and are described in greater detail in the text that follows. In FIGS. 1 through 3, the leftmost portion shows elements that are generated by the software, the middle portion shows elements that are provided by the user to the software, and the rightmost portion shows elements that are provided by the software to the user. Each of FIGS. 1 through 3 denotes elements as being provided “from user” or being provided “to user”, although it will be understood that “user” may refer to one or more users, as in a group of users, and that an element may be provided to/from one user in a group, while another element may be provided to/from a different user in the group or to the same user in the group. Alternatively, there may be only a single user.

FIG. 1 is a flow chart of the “sharing” or “collaborating” aspect of the backlight design software. A user provides component design information 21 and/or backlight design information 23 to the software.

The component design information 21 may include information about one or more components in the design. In one embodiment, the component design information is selected from a menu or list of existing components. For instance, the user may pick a particular thin film from a list of known thin films, and the software may refer to a database to obtain specific physical parameters of the selected thin film. Alternatively, the user may directly specify one or more known physical parameters of the thin film. As a further alternative, the user may specify the thin film from scratch by entering values for all of the physical parameters. The component design information 21 may also include the location and/or orientation of each component, in addition to information about the component itself. The backlight design information 23 may include information about the design itself, analogous to the component design information 21.

The component design information 21 and/or the backlight design information 23 may be referred to as simply “design information”. The design information may be used to form a backlight design 14.

A backlight design 14 may include properties of the various components in a particular layout, as well as their particular orientations to each other. In one embodiment, the backlight design 14 may include a location and orientation for each of the components. In another embodiment, the backlight design 14 includes a cavity with a particular set of dimensions, at least one light source inside the cavity, and at least one thin film for adjusting the angular and/or polarization properties of a transmitted beam through the thin film(s). In many cases, the thin films are located along an exterior wall of the cavity, although this is not a strict requirement.

The software performs a simulation of the backlight design 14 to produce at least one set of performance results 15. The simulation typically includes at least one ray trace, although other types of simulations may be performed as well. During a typical simulation, rays originate at the light source(s), propagate through the optical system of the backlight design 14, and eventually exit through the thin film(s), toward the viewer. For a typical simulation, the incident and/or exiting angles and/or positions of the rays are tabulated in a probabilistic manner to produce a predicted brightness, which varies as a function of screen location and exiting angle. This tabulation may be analogous to a histogram, in which the location and exiting angle of an exiting ray may fall in a particular “bin”. The number of bins and the size of each bin may be determined by a default value calculated by the software, a default value programmed into the software, or may be determined by the user. The exiting angle may be specified in two directions, such as an incline with respect to a horizontal dimension and with respect to a vertical dimension, although other references and angular conventions may be used as well. Note that other quantities may be simulated as well, including overall cost, component cost, manufacturing cost, energy efficiency, heat buildup and other thermal effects.

The performance results 15 may include a numerical or tabular representation of the predicted brightness as a function of location and angle, and may optionally include additional values calculated from the predicted brightness, such as uniformity across the display area, deviation from a particular desired brightness profile, and/or angular quantities that can describe the drop in brightness as a function of angle. A particular angular quantity may include a full-width-half-max, and/or an angle at which the brightness drops by 10% or any other suitable benchmark. Such an angular benchmark can depend on the particular application for the backlight design 14. A figure of merit may be included with the performance results, which can describe numerically the deviation between the predicted performance of the backlight design and the desired performance for the design. For instance, a target performance may be a maximum brightness variation of 2% over the display area for normal incidence, and the corresponding figure of merit may describe this mathematically, so that a particular figure of merit is maximized or minimized when the brightness variation is minimized. Other suitable figures of merit may be used as well. The figure of merit may also be used as a benchmark to compare designs to each other, including a designer's own iterations. Furthermore, the figure of merit may be used in an automated optimization routine, in which one or more component parameters is varied in order to maximize or minimize the figure of merit.

The software includes at least one annotation feature, in which the user supplies annotation data for the component(s), the backlight design 14, and/or the performance results 15. The annotation data may include comments from a designer or from other users, version or iteration numbers, a version history, design targets, and/or information obtained from an analysis of the performance results, such as luminance uniformity, color uniformity, angular performance, efficiency, and/or absorption by individual components. In addition, some or all of the annotation data may be generated by the software. The software receives the annotation data from the user, and stores the annotation data with the corresponding component(s), backlight design 14, and/or performance results 15. The annotation data may be stored in the same file as the corresponding component(s), backlight design 14, and/or performance results 15, and/or a file different from that of the corresponding component(s), backlight design 14, and/or performance results 15. In either case, the component annotation data 22 supplied by the user, by the system, or by other users forms an annotated component 32 that may be accessed by the user. Similarly, the combination of the backlight design 14 and the backlight design annotation data 24 forms an annotated backlight design 34 that may be accessed by the user, and the combination of the performance results 15 and the performance results annotation data 25 forms annotated performance results 35 that may be accessed by the user. Note that in all of these cases, the user that supplies the annotation data may be the same or may be different from the user than accesses the annotated component 32, the annotated backlight design 34, and/or the annotation performance results 35.

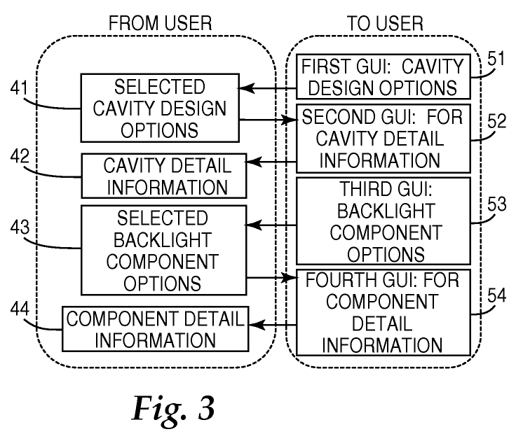

FIG. 2 is a flow chart of the “metadata” aspect of the backlight design software. As in FIG. 1, the component design information 21 and/or the backlight design information 23, together referred to as simply “design information,” may be used to form a backlight design 14. The software simulates one or more backlight designs 14 and produces performance results 15. The software automatically analyzes the component design information 21, the backlight design information 23, the backlight design 14, and/or the performance results to produce analytical information 36. Alternatively, the software may automatically analyze design process data or other meta-data to produce analytical information 36.

Alternatively, the software may use the design information to produce more than one backlight design 14, each of which may produce its own performance results; any combination of the backlight designs and their respective performance results may contribute to the analytical information 36.

The analytical information 36 may include various properties that are obtained from analysis of the performance results 15. These properties may include luminance uniformity, color uniformity, angular performance, efficiency, and/or absorption by one or more particular components.

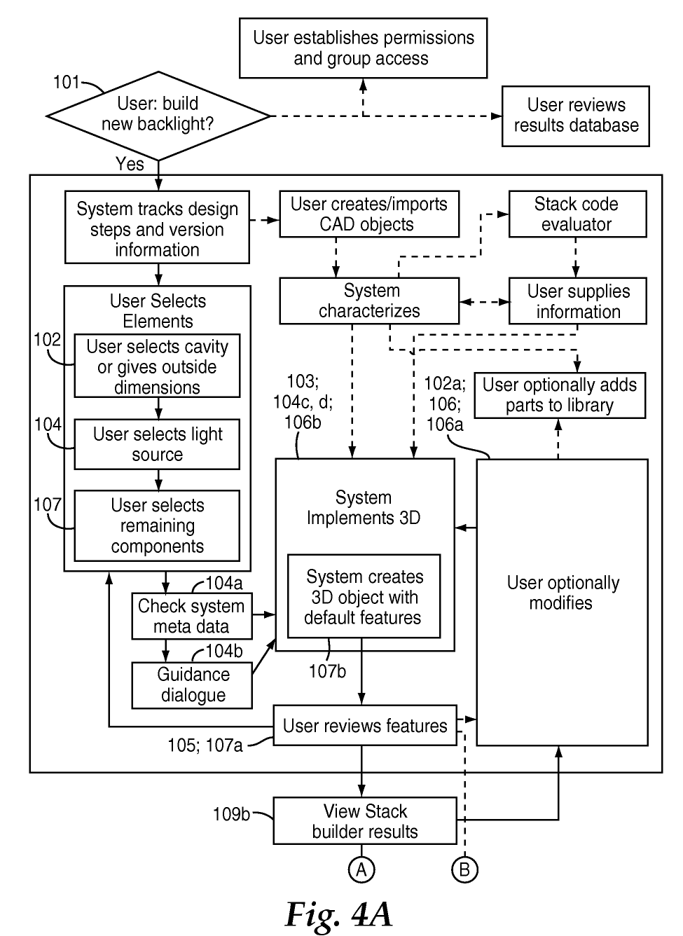

FIG. 3 is a flow chart of the “workflow driven” aspect of the backlight design software. There are various graphical user interfaces (GUIs) that are presented to the user in sequence, which allow the user to select and/or input various options or details about the design and/or components in the design. In essence, the “workflow driven” aspect may be considered to be a type of “backlight wizard,” which may guide the user through the process of specifying a design through the various prompts and screens of the GUIs.

The software provides a first GUI 51 to the user, which presents various cavity design options to the user. In one embodiment, the options are presented as choices from a menu. The user picks one or more of the cavity design options. Based on the selected cavity design options 41, the software provides a second GUI 52 to the user that can receive details about the cavity, or cavity detail information 42, from the user. For instance, the cavity design options may include such categories as “cell phone”, “computer display”, “backlit signs” and/or “television.” Once the user selects one or more of the cavity options, the software may prompt the user for the specific size of the cavity. The details, such as cavity size, may be entered manually and/or may be entered through additional selection from a menu. For instance, the cavity size may be chosen in a menu fashion by selection of a particular device manufacturer and/or common screen size. Other quantities that may be selected from menus and/or specified manually are cavity length, width, height, flat vs. curves or patterns to the cavity walls, material property, surface covering and surface texture. Note that the “cavity” designs may be referred to as “backlight” designs, and that the “cavity” in a particular design need not be hollow, and may include solid portions or may be entirely solid.

As a specific example, the selected cavity design options 41 may include a “box” as the initial cavity shape, selected from a menu. The cavity detail information 42, may include dimension of height, width and depth, entered by the user in appropriate units, wall shape of flat sides, corners and bottom, selected from a menu of possible shapes, material property of diffuse white reflector, selected from a menu of material properties, surface covering of “none”, selected from a menu, and surface texture of “none”, also selected from a menu.

In addition to specification of a cavity, the software allows for similar choice and specification of at least one component in the design. The software provides a third GUI 53 to the user, where the user selects one or more backlight component options. Based on the selected backlight component options 43, the software provides a fourth GUI 54 to the user that receives component detail information 44. For instance, the backlight component options may include thin films that can alter the angular output properties of the backlight. The options may include categories of thin films, such as “diffuser”, “polarizer”, “brightness enhancement film” and so forth. These choices may be presented to the user in a menu or other suitable mechanism for selection. Once the user selects one of the categories, such as “brightness enhancement film”, the software prompts the user for more specific information, such as the particular commercially-available “brightness enhancement film”. The component detail information 44 may be selected from a menu, such a listing of all available “brightness enhancement films”, may be entered directly without selection from a menu, or may be a combination of menu item(s) and manually entered value(s).

As a specific example, the user selects a backlight component option of “light sources”. The user then selects “CCFL” from a menu of available type of light sources, such as CCFL and LED. The user selects a lamp type and model from a menu of available CCFLs. The user enters directly the number of lamps, such as “3”. The user enters the orientation of the lamps from a menu of “vertical” and “horizontal”. The user may add additional lamps after the initial number is chosen. The user may highlight a lamp and delete it. The user may distribute the lamps evenly along a wall, with a particular button click. The user may optionally view pictorially the value of the absolute distance of each lamp from other landmarks in the design. The user may see the distance or gap between the lamps. The user may change or adjust the positions of the lamps in the vertical and horizontal dimensions. The user may change the unit of distance. The user may view the value of the margin at the edges of the cavity, and may change the margin value by entering it directly. The user may back out and cancel all actions. The user may review the design in a graphical manner, and may rotate, snap to one of several standard views, and zoom. The user may resize the cavity and have all parts (lamps) resize automatically. The user may also revert to an earlier menu and select “LED”.

Use of the third GUI 53 and fourth GUI 54 may be repeated sequentially to add further components to the backlight design. This may be repeated until the backlight design is complete.

Note that software may specify an order for specifying the cavity and components in the design. For instance, the information corresponding to the cavity may be entered first, followed by the information corresponding to the light source or light producing component(s), followed by the information corresponding to the remaining components, such as diffusers, films, and so forth. Alternatively, other orders may be used. In general, having the information entered in a particular order, such as cavity/source/components, may be helpful for the user and may even reduce the time required to enter the design information.

Note that the first, second, third and fourth GUIs may or may not be different from each other. For instance, in one embodiment, they are all different from each other, so that the entering of data in one GUI brings up an entirely different GUI for the next set of data. In another embodiment, a single GUI may appear in one portion of the screen, while other portions of the screen may change in response to entered data, such as a toolbar, or a navigation menu. In this manner, any or all of the GUIs may be the same, or may be different from each other.

Note that the software may be implemented in any of several ways. Because of the many ways in which the software may be implemented, it is instructive to specifically define the term “server” for the purposes of this document. A “server” may include any one of the following configurations, described in the following paragraph.

For instance, the software may run entirely locally on a computer, without any external communication to a network or to any other machines. Alternatively, all or portions of the software may run locally on a computer, with external communication to a network or to other machines. For instance, the calculations involved with raytracing may be performed locally, while a database containing component descriptions may be accessed remotely. As a further example, the raytracing calculations may be performed remotely, while results and/or components and/or designs may be stored on a local machine. As yet another example, the raytracing calculations may be performed remotely and all of the results, components, and designs may also be stored remotely; this scenario may occur with an implementation on the Internet, in which a user accesses a screen as if it were essentially a so-called “dumb terminal”, with the storage being performed remotely on a server, and the calculations also being performed on a server, which may or may not be the same server on which the storage is performed. Alternatively, the software may run on a distributed network, where various computers are networked together but lack a central server. This distributed network may include a so-called “calculation farm”, in which sets of calculations, such as raytraces, are directed from a user's machine to the calculation farm, run on a machine selected by the calculation farm, and are delivered back to the user's machine. The distributed network may include distributed data storage, where, for example, metadata for a user is stored on the user's computer but is accessible to all machines of the system.

The software may be run in any suitable language and under any suitable operating system, each of which will be well-known to one of ordinary skill in the art.

The following four examples show in varying degrees of detail how the software may be implemented. These are merely exemplary, and should not be construed as limiting in any way.

### Example 1

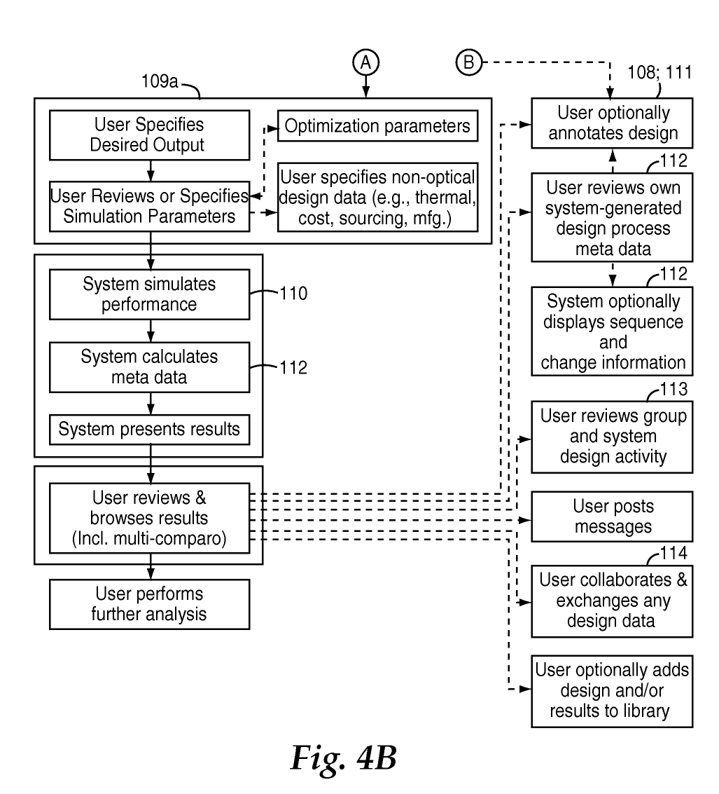

FIGS. 4A-B include a flowchart of an exemplary process flow for one specific embodiment of the backlight design software. Various cells in the flowchart are numbered, and these numbered cells are explained further in the paragraphs that follow. The following is a description of some exemplary features of the software used by a typical backlight designer. Each paragraph in this example corresponds roughly to a step taken by a designer.

The designer logs onto the Virtual Backlight system to quickly design a TV backlight that has brightness uniformity. The designer opens the virtual backlight software and starts from scratch on a new design. (Element 101)

The designer selects the basic cavity design and specifies the exterior dimensions. (Element 102) This is primarily a “workflow driven” aspect of the software.

The 3D geometry model of the structure appears as a CAD geometry model in the design window. (Element 103)

The designer selects four of a certain model LED to place in the backlight. (Element 104) This is primarily a “workflow driven” aspect of the software.

The system reviews LED patterns based on its latest analysis of system-wide design behavior. (Element 104a) This is primarily a “metadata” aspect of the software.

As a result of the system-wide review, the system offers a default pattern of four LEDs (RGBG; red green blue green) in diamond pattern. (Element 104b) This is primarily a “metadata” aspect of the software.

The designer accepts the suggested pattern as an initial design and the Virtual Backlight system uses its component library to create the CAD geometry models of 16 sets of LEDs needed to cover the backlight. (Element 104c)

The Virtual Backlight system places the LEDs in the proper locations in the backlight cavity by choosing the most typical arrangement for this certain cavity design. (Element 104d) This is primarily a “metadata” aspect of the software.

The designer then reviews the system-implemented LEDs and their layout. (Element 105) This is primarily a “workflow driven” aspect of the software.

The designer next chooses the other desired major component categories from a checklist. For example, the designer chooses to include multi-layer optical films, reflecting films, and a diffuser plate. (Element 107) This is primarily a “workflow driven” aspect of the software.

Upon “selection” the designer is taken to a review of the particular parameters associated with the system-suggested components. For example, the designer reviews the particular MOF, ESR and diffuser plate chosen at the previous step. (Element 107a) This is primarily a “workflow driven” aspect of the software.

If the designer is inexperienced or has no particular theory about which product to choose, he may simply have the Virtual Backlight system implement the suggested/default objects. (Element 107b)

The system then creates the virtual, 3D geometry models.

The designer enters a note to himself about what prompted this design configuration and what his goals are for the project. (Element 108) This is primarily “metadata” and “annotation” aspects of the software.

The designer chooses the type of desired output (which calculations) and the simulation options (e.g., how many rays are launched and how rays are terminated, etc.) (Element 109a) This is primarily a “workflow driven” aspect of the software.

Alternately, the designer views the simulated output of the stack of optical components and decides whether design alterations are called for before implementing the stack of optical components in the backlight cavity. (Element 109b) This is primarily a “workflow driven” aspect of the software.

The designer then waits 20 minutes to view the output in a standard report format. (Element 110) This is primarily a “workflow driven” aspect of the software.

Over the course of 10 design iterations, the designer makes a number of changes to the backlight design, each time making a few notes about what motivates the change, including some changes to the surface properties of the films, and the arrangement of LEDs. (Element 111) This is primarily “metadata” and “annotation” aspects of the software.

The system has kept track of the design changes the designer has made and keeps a summary of that information. By reviewing his own design process the designer sees an opportunity to change the painted dot pattern. (Element 112) This is primarily a “metadata” aspect of the software.

The designer searches the database of other designs from his work group in order to see what other designs exist in this design space. (Element 113) This is primarily “metadata” and “sharing” aspects of the software.

The designer wants to get some input on the design from a colleague who has developed a similar design and sends that designer a version of his new design and results along with notes about what kind of input he would like. (Element 114) This is primarily a “sharing” aspect of the software.

The designer also takes a copy of the colleague's design and makes a further adjustment to it and sends that version to the colleague with comments. This is primarily “metadata”, “annotation” and “sharing” aspects of the software.

### Example 2

In this example, a business person/manager uses the Virtual Backlight system metadata features to manage the product development process.

Sally is responsible for managing four backlight modelers on site and two modelers at a remote location. Each week she checks the virtual backlight system metadata pages to review such summary data as a heat map showing the number and type of components that modelers are using in their designs, the number of simulations associated with certain system designs, and the figures of merit associated with specific designs. The metadata enables her to have more productive conversations with the people she manages because she can “see” where the new designs are going at a level that is above the description of individual projects and daily issues.

She also uses the meta-data features to track how designs evolve in the entire design space of components and their combinations. For example, she could use the meta-data to notice a white space opportunity that is not currently being explored.

### Example 3

In this example, a researcher/product developer uses the Virtual Backlight system as a knowledge resource.

Ellen has been assigned a new project to design a multi-colored LED. As part of her background research, she logs into the virtual backlight system to search the metadata for existing or past projects that are related to her current focus. For example, she opens the results pages and searches for projects containing LEDs which achieved a minimum brightness output. She notices three projects that meet her criteria and after reviewing the backlight designs, the summary reports on the systems, and the particular component designs in the library, she opens the contact information for each designer. She writes to one asking for any additional information that might not be in the system, she calls another to clarify what was meant in some of his annotation about heat buildup problems predicted by the virtual backlight system, and she sends a third designer a quick modification she made to his version of an LED model and requests feedback.

### Example 4

In this example, a technical service person uses the Virtual Backlight system.

John works in technical service and so must keep on top of all technical developments. In addition to monitoring the metadata of the entire system each week, John searches the results archives to find contacts and existing modeling results that address customer-specific questions. He is able to respond more quickly to customer requests because the system not only provides immediate access to high-level information that is relevant, it allows him to drill down to explore modeling results in detail as needed. John is also able to quickly find the right people associated with a relevant project by “qualifying” the potential internal contacts by the specific details associated with projects.

The preceding four examples are intended to clarify the three aspects of the Virtual Backlight software described above, and should not be construed as limiting in any way. The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

1. An application server for interacting with a plurality of users through respective user computers to design a backlight, the application server being configured for:
receiving design information relating to a backlight or component(s) thereof from at least one of the users;
generating a backlight design as a function of the design information;
simulating the backlight design to produce performance results;
receiving from at least one of the users annotation data relating to at least one of: (a) the backlight or the component(s) thereof, or (b) the performance results;
annotating the backlight, the component(s) thereof, and/or the performance results with the annotation data; and
providing the annotation data to the users.

2. The server of claim 1, wherein the annotating step associates the annotation data with the corresponding annotated backlight, component(s) thereof, and/or performance data.

3. The server of claim 1, wherein the receiving step includes receiving from a first user first annotation data relating to the backlight, component(s) thereof, and/or performance results thereof, and receiving from a second user second annotation data relating to the same backlight, component(s) thereof, and/or performance results thereof.

4. The server of claim 1, wherein the receiving step includes receiving from a first user first annotation data relating to the backlight, component(s) thereof, and/or performance results thereof, and later receiving from a second user second annotation data relating to the same backlight, component(s) thereof, and/or performance results thereof.

5. The application server of claim 1, wherein the performance results include a figure of merit.

6. The application server of claim 5, wherein the simulating step includes using the figure of merit in at least one optimization routine.

7. The application server of claim 1, wherein the backlight design comprises a location and orientation for each of the selected components.

8. The system of claim 1, wherein the annotating step is performed automatically by the application server.

9. A computer system for interacting with at least one user to design a backlight, the computer system being configured for:
receiving a plurality of design information relating to at least one backlight or component(s) thereof from at least one user;
generating at least one backlight design as a function of the design information;
simulating the at least one backlight design to produce performance results;
analyzing automatically at least one of: (a) the plurality of design information, or (b) the at least one backlight design or the component(s) thereof, or (c) the performance results, to produce analytical information; and
providing the analytical information to the at least one user.

10. The system of claim 9, wherein the generating step generates a plurality of backlight designs, and wherein the analyzing step compares the plurality of backlight designs.

11. The system of claim 9, wherein the simulating step produces performance results for a plurality of backlight designs, and wherein the analyzing step compares the performance results for the plurality of backlight designs.

12. The system of claim 9, wherein the analyzing step is performed automatically by the application server.

13. A computer system for interacting with at least one user to design a backlight, the computer system being configured to execute the steps of:
(a) providing a first graphical user interface containing a plurality of selectable cavity design options;
(b) receiving the selected cavity design options from the user;
(c) after step (b), providing a second graphical user interface adapted to receive cavity detail information, the type of cavity detail information being a function of the cavity design options selected by the user;
(d) receiving the cavity detail information from the user;
(e) providing a third graphical user interface containing a plurality of selectable backlight component options;
(f) receiving the selected backlight component options from the user;
(g) after step (f), providing a fourth graphical user interface adapted to receive component detail information, the type of component detail information being a function of the backlight component options selected by the user; and
(h) receiving the component detail information from the user.

14. The computer system of claim 13, wherein the first, second, third and fourth graphical user interfaces are all different from each other.

15. The computer system of claim 13, wherein at least two of the first, second, third and fourth graphical user interfaces are the same as each other.

16. The computer system of claim 13, wherein steps (a) through (d) are performed before steps (e) through (h).

17. The computer system of claim 13, wherein steps (a) through (d) are performed after steps (e) through (h).
